(19) United States
(12) Patent Application Publication
(10) Pub. No.: US 2017/0154338 A1
(43) Pub. Date: Jun. 1, 2017

(54) DEVICE AND METHOD TO MEASURE AND ENSURE COMPLIANCE WITH VEHICLE RECALLS OR MANDATORY SERVICE UPDATES

(71) Applicant: Drew Technologies, Inc., Ann Arbor, MI (US)

(72) Inventors: Thomas Fournier, Tuscon, AZ (US); Lothar Geilen, Coral Gables, FL (US); Brian Herron, Dexter, MI (US)

(21) Appl. No.: 15/353,809

(22) Filed: Nov. 17, 2016

Related U.S. Application Data
(60) Provisional application No. 62/261,582, filed on Dec. 1, 2015.

(51) Int. Cl. G06Q 30/00; G07C 5/00; G07C 5/08

(52) U.S. Cl. CPC G06Q 30/014; G06Q 30/018; G07C 5/085; G07C 5/008

(57) ABSTRACT

A device to measure and ensure compliance with vehicle recalls and/or mandatory service updates includes a processor, a communication device in communication with the processor, the communication device being configured to connect to one or more electronic control modules of a vehicle and a database in communication with the processor. The database contains (a) identifying data that identifies specific makes and/or models and/or Vehicle Identification Number (VIN) series that are subject to recalls or updates, and (b) recall data as to the nature of the recalls and/or updates, associated software revision numbers of the recalls and/or updates, and identifying recall numbers and/or names of the recalls and/or updates. The processor is configured to interrogate a vehicle's computer systems such that information confirming the completion of a recall or update is retrieved and compared against the database.

### CROSS REFERENCE TO RELATED APPLICATION

This application claims priority to U.S. Provisional Application No. 62/261,582 filed on Dec. 1, 2015, all of which is herein incorporated by reference in its entirety.

### BACKGROUND

1. Field of the Invention

The invention generally relates to devices and methods for determining compliance with motor vehicle recalls and mandatory service updates related to vehicle safety or emissions.

2. Description of Related Art

The increasing technological complexity of motor vehicles has coincided with an increasing need to recall and/or update specific make/models after sale to correct latently discovered design or manufacturing faults. Compliance with government and/or vehicle manufacturer recalls, and mandatory service updates are particularly important when those recalls or updates are meant to repair faults related to vehicle safety or emission performance. The increase in vehicle complexity is driven, in large part, by an increasing reliance on software driven electronic control modules applied to a widening range of vehicle subsystems—e.g. engine, transmission, body, lighting, doors, navigation, entertainment, collision, and more. Modern vehicles, in some cases, employ more than one hundred computer processors on a single vehicle. The software algorithms associated with these processors control or augment nearly every aspect of vehicle performance including but not limited to: power output, control responsiveness, road traction, fuel mileage, pollution emissions, passenger comfort, collision detection and associated response. Additionally, the current massive investments being made by vehicle manufacturers and transportation companies in the field of motor vehicle driver automation will dramatically increase this already high reliance on software driven electronic controls of vehicle performance.

### SUMMARY

The automotive aftermarket currently lacks a reliable method for determining whether a given vehicle has been repaired and updated according to the published recalls and updates applicable to it. Federal, state, and smaller jurisdictional governments have a need for compliance information in order to ensure that the motor vehicles traveling public roads are safe and operating within allowed pollution emissions limits. Similarly, private individuals purchasing used motor vehicles also have a need for this information to be assured they are purchasing a safe, low polluting vehicle. Used car buyers must currently rely on recall and update repair paperwork from dealerships that is saved by the prior owner and presented at time of sale. This paperwork is rarely complete if it exists at all.

By way of example, a leading vehicle manufacturer has recently admitted to installing defective software in certain of their vehicles to defeat the emissions control systems in trade for better fuel mileage and power performance. That manufacturer has agreed to recall those vehicles and install corrected software; however, many of their customers have expressed intent to avoid the update so as to keep their current high mileage and high power performance. Unless a reliable method to establish and track compliance is provided, the effectiveness of that recall will be in question.

The invention may comprise a device and method to positively determine whether recalls and/or updates have been complied with on a given vehicle and across a fleet. In one embodiment, the device includes a computer database containing information that identifies specific makes and/or models and/or Vehicle Identification Number (VIN) series that are subject to recalls or updates. The database also includes specific information as to the nature of the recalls and/or updates, their associated software revision numbers (if any), and their identifying recall numbers and/or names. The embodiment may also include an electronic device and associated software that interrogates the vehicle's computer systems via the On-Board Diagnostic (OBD) port such that information confirming the completion of a recall or update is retrieved and compared against the database.

### BRIEF DESCRIPTION OF THE FIGURES

FIG. 1 illustrates a block diagram of a device to measure and ensure compliance with vehicle recalls or mandatory service updates, wherein the device is connected to a vehicle under inspection via a wired connection;

FIG. 2 illustrates a block diagram of a device to measure and ensure compliance with vehicle recalls or mandatory service updates, wherein the device is connected to a vehicle under inspection via a wireless connection;

FIG. 3 Illustrates a block diagram of a device to measure and ensure compliance with vehicle recalls or mandatory service updates, wherein the device is connected to a remotely located database; and

FIG. 4 illustrates a flowchart of a method to measure and ensure compliance with vehicle recalls or mandatory service updates

### DETAILED DESCRIPTION

Modern vehicles are ‘calibrated’ to deliver certain performance. This calibration necessarily trades off combinations of power, mileage, emissions, handling and ride comfort to achieve a particular performance outcome. This calibration occurs via the software algorithms programmed into the vehicle's electronic control modules. The specific version of calibrating software is tracked via an electronically stored ‘calibration identification’ (CALID). When vehicle manufacturers must recall a particular set of vehicles and that recall involves a fault repair that is fixed by a software revision, a new CALID is issued and programmed into the relevant control module.

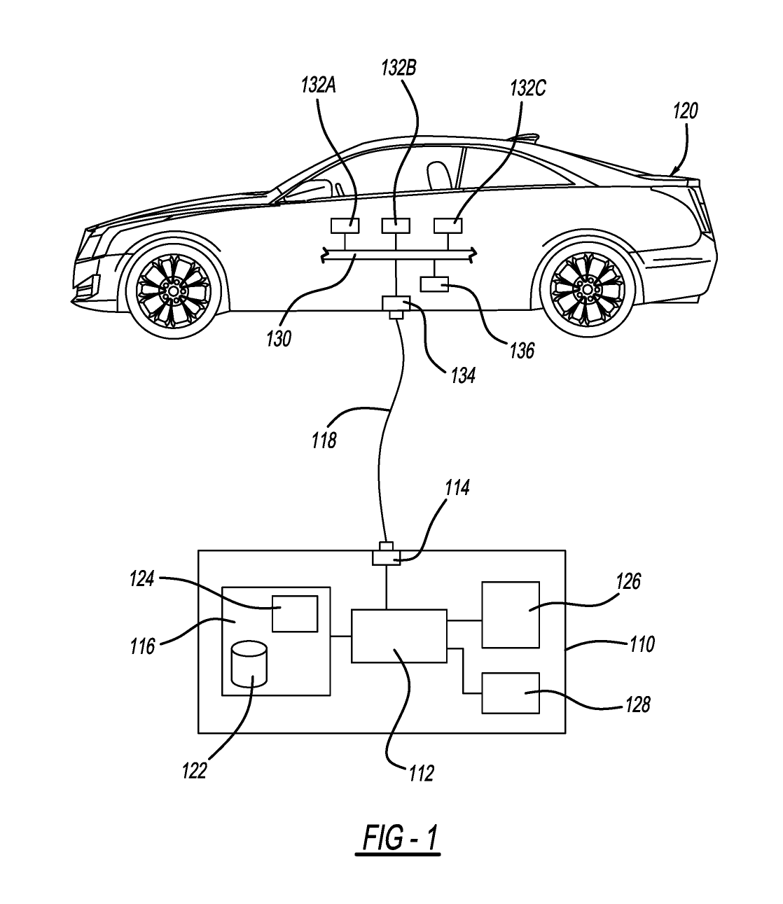

Referring to FIG. 1, a device 110 to measure and ensure compliance with vehicle recalls or mandatory service updates is shown. Generally, the device 110 includes a processor 112 in communication with a communication device 114 and a memory device 116. The processor 112 may be a single microprocessor or may be a plurality of microprocessors working in concert together. The memory device 116 may be any memory device capable of storing digital information. As such, the memory device 116 may be a magnetic storage device, an optical storage device, a solid-state storage device, or any suitable device capable of storing digital information. The communication device 114 may be any device capable of allowing for the processor 12 to communicate with other electronic systems outside the device 110 itself. For example, the communication device 114 may be an OBD type device capable of connecting to an OBD cable 118. The OBD cable 118 uses an SAE J1962 type connector and utilizes the SAE J2534 transmission protocol to communicate with an external device, such as the vehicle 120.

The memory 116 of the device 110 may include a database 122 that keeps a current listing of CALIDs or other data associated with recalls and/or updates of vehicles. Further, the memory device 116 may also include a set of instructions 124 capable of configuring the processor 112 to perform any one of the methods disclosed in this specification. A more detailed description of both the database 122 as well as the instructions 124 will be provided later in this description.

The device 110 may also include an output device 126 and/or an input device 128 that is in communication with the processor 112. The output device 126 is capable of providing output to a user of the device 110. For example, the output device 126 may be a visual or audible type device, but could also be a port for connecting to an external device, like a network, display, speaker, or printer.

In one example, the output device 126 may be one or more LEDs or may be a display device capable of displaying information for a user of the device 110 to see. In like manner, the output device 126 could also be an audible output device capable of relaying information to a user of the device 110 by audio communication.

The input device 128 may be any device capable of providing input to the processor 112. For example, the input device 128 could simply be a switch or push buttons or may be a plurality of switches or push buttons. It is also possible that the input device 128 be a port that is capable of connecting to other types of input devices, such as external keyboards, mice, microphones, and the like. In the case that the input device 128 includes a port, this port could be utilized to provide updated information to the database 122.

As stated earlier, the device 110, in this embodiment is in communication with a vehicle 120 by use of a cable 118, which may be an OBD type cable. The vehicle 120 may include a vehicle bus 130. The vehicle bus may be any vehicle bus utilized in vehicles, such as a controller area network (CAN) type bus, commonly found in automobiles. Connected to the bus 130 are one or more electronic control modules 132A, 132B, and 132C, which may be a part of one or more vehicle subsystems. It should be understood that the bus 130 may be connected to any one of some different electronic control modules and should not be limited to three electronic control modules. These electronic control modules 132A, 132B, and/or 132C may be vehicle systems that relate to the vehicle's emissions, safety systems, transmissions, body, lighting, doors, navigation, entertainment, collision, and more. It should be understood that the electronic control modules 132A, 132B, and/or 132C could be part of any vehicle subsystem of the vehicle 120.

In addition to the electronic control modules connected to the bus 130, the bus 130 may also be connected to an OBD type port 134. This OBD type port 134 is capable of being connected to the OBD cable 118 by using an SAE J1962 type connector. As such, in this embodiment, a communication protocol utilized to communicate with the port 34 would be the SAE J2534 communication protocol.

Furthermore, the vehicle 120 may also include one or more memory devices 136. These one or more memory devices 136 may be a part of the vehicle subsystems 132A, 132B, and/or 132C or may be separate and apart from the vehicle subsystems. Here, the memory device 136 is shown to be directly connected to the bus 130. It should be understood that the memory device 136 may be any type of memory device capable of storing digital information. As such, the memory device 136 may be, as an example, a magnetic storage device, an optical storage device, and/or a solid-state storage device.

As to the vehicle 120, it should be understood that the vehicle 120 might be any vehicle capable of transporting persons or goods from one point to another. As such, the vehicle may be a car, light truck, heavy-duty truck, tractor-trailer, tractor, or another type of vehicle. In addition to these vehicles listed, the vehicle 120 could also be a train, airplane, and/or watercraft.

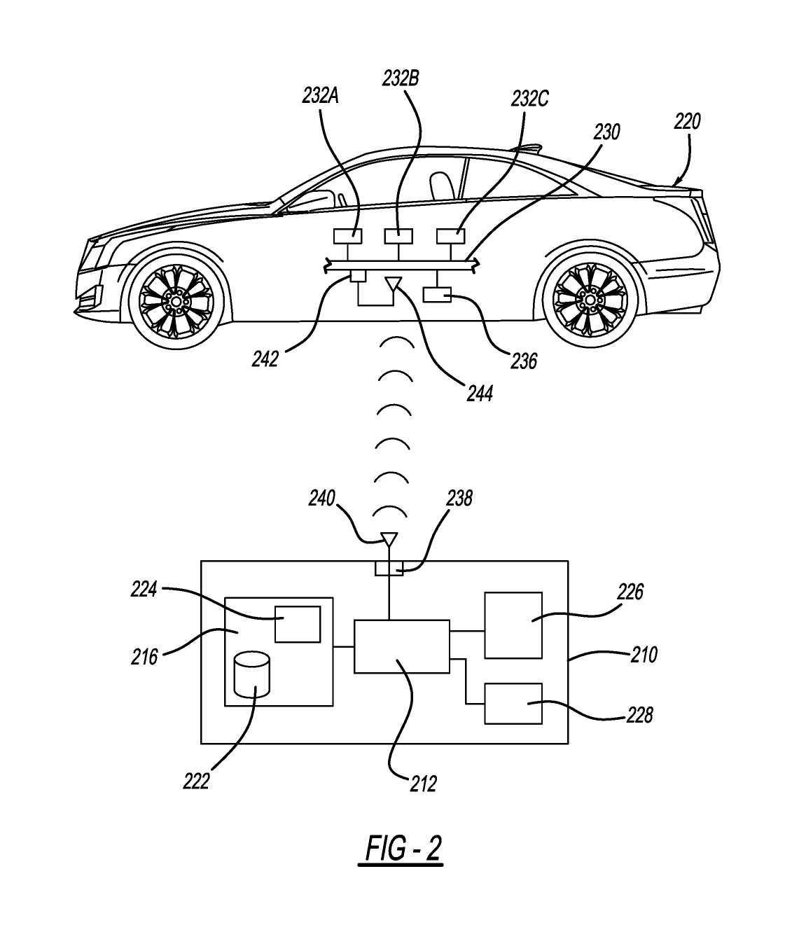

FIG. 2 illustrates a different embodiment of the device 210, wherein the device 210 is in wireless communication with the vehicle 220. It should be noted that like reference numerals have been utilized to refer to like elements, with the exception that these reference numerals have been increased by 100. As such, additional description will not be provided regarding the similar elements.

In this embodiment, the device 210 includes a network access device 238 capable of sending and receiving wireless communications via an antenna 240. These wireless communications may be sent or received using a wireless protocol, such as IEEE 802.11x or Bluetooth. However, it should be understood that any wireless transmission protocol could be utilized. Furthermore, the vehicle 220 also includes a network access device 242 capable of sending or receiving wireless communication signals via an antenna 244. When sending or receiving information from the device 210, the vehicle 220 would utilize the same communication protocol so that information may be exchanged between the vehicle 220 and the device 210.

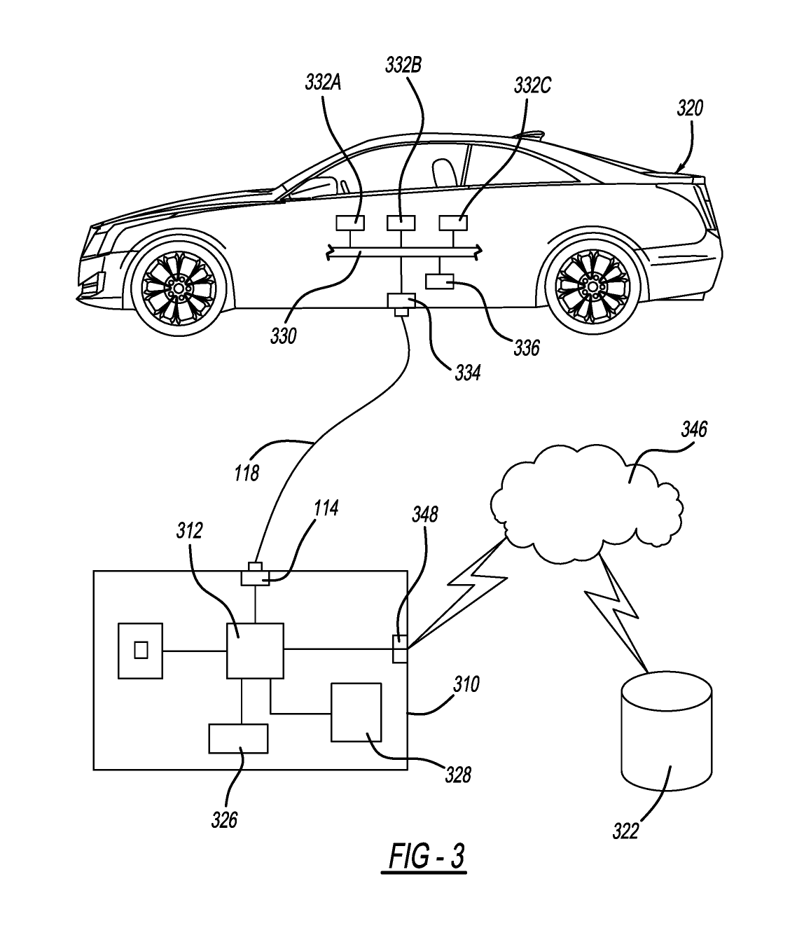

Referring to FIG. 3, another embodiment of the system 310 is shown. Like before, like reference numerals have been utilized to refer to like elements, with the exception that these elements have been incremented by 100. Here, the device 310 includes a network access device 348 capable of communicating with a remotely located database 322 via a network 346. The network 346 may be any computer network capable of exchanging information between different devices. However, in this embodiment, the network 346 may be the Internet and the database 322 may be stored on one or more servers that are in communication with the network 346.

This embodiment has the advantage in that the device 310 does not store the database 322 locally to the device 310, such as shown in FIG. 1. This allows the database 322 to be located to be updated as need be with additional information relating to recalls or mandatory service updates. As such, it is possible that vehicle OEMs could have the ability to update the database when new update or recall information becomes available. This essentially allows the user of the device 310 to always have access to the newest updates are recalls, so long as device 310 can communicate with the remote database 322. Additionally, while this embodiment utilizes a wired cable 318 to connect the vehicle 320 to the device 310, it should be understood that a wireless communication might also be utilized as shown in FIG. 2.

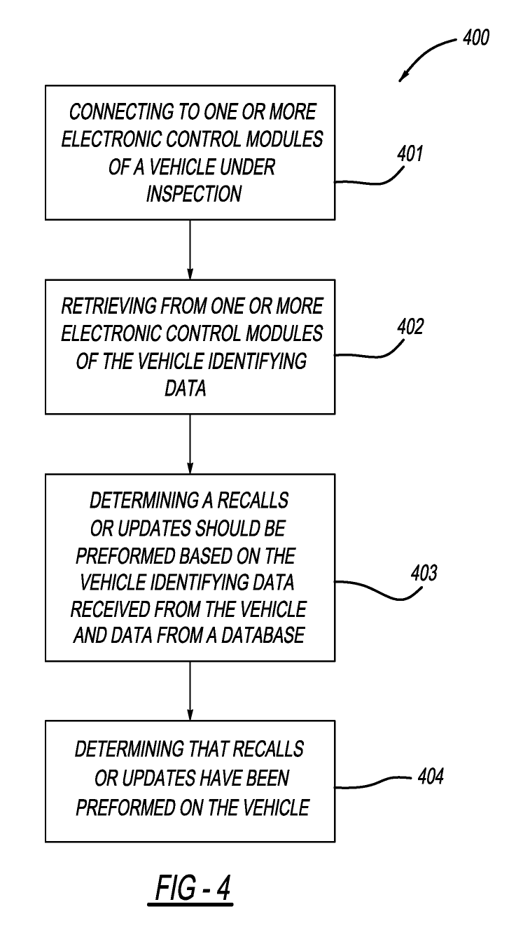

Referring to FIG. 4, a method 400 to ensure compliance with vehicle recalls or mandatory service updates by the devices 110, 210, and 3120 shown in FIGS. 1, 2, and 3, respectively, is illustrated. The method 400 may be located within the instructions 124, 224, and 324 of FIGS. 1, 2, and 3, respectively.

Before describing the method 400 further, it should be understood for the sake of simplicity; the following description will refer to the embodiment shown in FIG. 1. However, it should be understood that the following description is equally applicable to the other embodiments disclosed in FIGS. 2 and/or 3.

In step 401, the processor 112 is configured to connect to one or more electronic control modules 132A, 132B, and/or 132C of the vehicle 120 that is under inspection. In step 402, the processor 112 of the device 110 is configured to retrieve identifying data from one or more electronic control modules 132A, 132B, and/or 132C of the vehicle 120. This identifying data may include specific make and/or model of the vehicle under inspection 120 or may include a vehicle identification number of the vehicle under inspection. This identifying data may also contain information relating to any updates or recalls that have been performed on the vehicle 120.

In step 403, the processor 112 is configured to determine which recalls or updates should be performed based on the identifying data received from the vehicle 120 and data from the database 122. The database 122 may contain data that identifies specific makes and/or models or vehicle identification numbers that are subject to recalls or updates and recall data. The recall data may include the nature of the recalls or updates, associated software revision numbers of the recalls or updates, and/or identifying recall numbers or names of the recalls or updates. Furthermore, the database may comprise a current listing of CALIDs associated with recalls or updates. As such, in this step, the processor 112 is configured to check the data found in the database 122 if any of the data relates to the vehicle 120 by using the identifying data received from the vehicle 120.

In step 404, the processor 112 is configured to determine that the recalls or updates have been performed on the vehicle 120. There are a number of different ways, which this determination may be made. For example, the method in step 402 may receive information from the vehicle in the form of a CALID from the vehicle 120 under inspection. In step 404, the CALID received from the vehicle 120 under inspection may be compared to a current listing of CALIDs associated with recalls or updates for that vehicle that are stored in the database 122. A match of the at least one CALID retrieved from the vehicle 120 under inspection with at least one of the current listing of CALIDs of the database 122 would indicate that a specific recall or update has been performed.

In another embodiment, in step 402, a vehicle identification number from the vehicle may be retrieved from the vehicle 120 under inspection. In step 404, a comparison of the vehicle identification number from the vehicle 120 under inspection can be compared to a database containing a listing of vehicle identification numbers of vehicles that are subject to recalls or updates. If the vehicle under inspection is subject to the recall or update, the processor 112 may further be configured to determine if the recall or update has been performed. This embodiment of the device 110 may also include software to retrieve vehicle identification number information that is currently available and stored in late model electronic control modules on the vehicle. The device 110 uses the retrieved vehicle identification number information to positively identify the vehicle 110 submitted for examination and to positively match that vehicle to the recall/update requirements associated with it.

In certain situations, the vehicle 120 under inspection may only include a list of CALIDs indicating which recalls or updates have been performed. As such, the method 400 may also allow for the creation of an inspection log on the memory device 136 of the vehicle 120. In this situation, the processor 112 is configured to create an inspection log stored in the storage device 136 of the vehicle 120 under inspection. The inspection log may include recall identification information including at least one time, date, location, identifying number, or name of completed recalls or updates programmed into the vehicle 120. This may be accomplished by authorized dealer service technicians at the time that recalls and/or updates are performed. This data may also be converted from the technician repair application and transmitted directly to the completion log in an automated process. This embodiment of the device 110 may include the described vehicle on board recall/update completion log in concert with software embedded in the device to retrieve previously entered recall/update log data along with CALID data. The combined log and CALID data is then compared to the database 122 of appropriate recall identification information and/or CALID information to determine whether all required recalls and/or updates have been performed.

The database 122 keeps a current listing of CALIDs associated with recalls and updates, or if a complete list is not available then alternately a list of CALIDs that are known to be obsolete and affected by a recall, and the device 110 retrieves the CALIDs of vehicles presented for recall and/or update verification. By comparing the CALID retrieved from the vehicle 120 to the approved recall/update CALID stored in the database 122, the device 110 makes a positive determination as to whether the recall/update has been complied with.

The recall compliance determination method 400 described here may be conducted as part of a routine periodic emissions and/or safety test mandated by state and/or local governments. Many jurisdictions within the United States currently conduct such routine periodic inspections, and the methodology would be a valuable addition to the integrity of their inspections. Additionally, the recall/update compliance method 400 could be conducted by private companies seeking to certify the safety and/or emissions compliance status of used motor vehicles that are up for sale. This service would benefit the prospective used car buyer enabling them to buy with increased confidence. Finally, the method 400 may be conducted by automotive dealerships and/or used car sales businesses seeking to ensure that the used car warranties they offer are sound business propositions.

Not all recalls and/or mandatory service updates are fixed by software changes made to the vehicle computer systems. Though the retrieval and comparison of CALIDs will capture a large portion of the safety and emissions related recalls, it will not capture all of them.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation, and change, without departing from the spirit of this invention, as defined in the following claims.

1. A device to measure and ensure compliance with vehicle recalls or mandatory service updates, the device comprising:
a processor;
a communication device in communication with the processor, the communication device being configured to connect to one or more electronic control modules of a vehicle under inspection;
wherein the processor is in communication with a database, the database containing (a) identifying data that identifies specific makes and models or Vehicle Identification Number (VIN) series that are subject to recalls or updates and (b) recall data that identifies which recall or updates should have been performed;
wherein the processor is configured to (1) retrieve identifying data from one or more electronic control modules of the vehicle that identifies specific make and model or Vehicle Identification Number (VIN) of the vehicle under inspection, (2) determine which recalls or updates should be performed based on the vehicle identifying data received from the vehicle and the identifying data and recall data from the database, and (3) determine that that recalls or updates have been performed on the vehicle under inspection.

2. The device of claim 1, wherein the recall data includes a nature of the recalls or updates, associated software revision numbers of the recalls or updates, and identifying recall numbers or names of the recalls or updates.

3. The device of claim 1, wherein the database further comprises a current listing of calibration identifications (CALIDs) associated with recalls or updates.

4. The device of claim 3, wherein the processor is configured to:
retrieve at least one CALID from the vehicle under inspection;
compare the at least one CALID retrieved from the vehicle under inspection with the current listing of calibration identifications (CALIDs) associated with recalls or updates from the database; and
determine that that recalls or updates have been performed on the vehicle based on the comparison of the at least one CALID retrieved from the vehicle under inspection with the current listing of calibration identifications (CALIDs) associated with recalls or updates in the database, wherein a match of the at least one CALID retrieved from the vehicle under inspection with at least one of the current listing of calibration identifications (CALIDs) of the database indicates that the recall or update has been performed.

5. The device of claim 2, wherein the processor is configured to modify or create an inspection log stored in a storage device of the vehicle under inspection, wherein the inspection log includes recall identification information including at least one time, date, location, or identifying number or name of completed recalls or updates programmed into the vehicle.

6. The device of claim 5, wherein the processor is configured to:
retrieve the recall identification information from the inspection log from the vehicle under inspection;
compare the recall identification information from the inspection log from the vehicle under inspection with the current listing of calibration identifications (CALIDs) associated with the current listing of recall identification information associated with recalls or updates in the database; and
determine that that recalls or updates have been performed on the vehicle based on the recall identification information in the inspection log, wherein a match of the recall identification information from the inspection log with at least one of the current listing of calibration identifications (CALIDs) of the database indicates that the recall or update has been performed.

7. The device of claim 6, wherein the inspection log of the vehicle under inspection includes both the calibration identifications (CALIDs) from the vehicle under inspection and the recall identification information.

8. The device of claim 1, wherein the database further comprises a listing of specific Vehicle Identification Numbers (VINs) of vehicles subject to recalls or updates along with relevant associated recall or update requirement information.

9. The device of claim 8, wherein the processor is configured to:
retrieve a Vehicle Identification Numbers (VIN) from the vehicle under inspection;
compare the Vehicle Identification Numbers (VIN) with the listing of specific Vehicle Identification Numbers (VINs) of vehicles subject to recalls or updates in the database; and
determine if the vehicle under inspection is subject to a recall or update;
determine if the recall or update has been performed.

10. The device of claim 1, wherein the database is located either remotely from the device or within the device.

11. A method to measure and ensure compliance with vehicle recalls or mandatory service updates by a device, the method comprising the steps of:
connecting to one or more electronic control modules of a vehicle under inspection;
retrieving from one or more electronic control modules of the vehicle identifying data that identifies specific make or model or Vehicle Identification Number (VIN) of the vehicle under inspection;
determining which recalls or updates should be performed based on the vehicle identifying data received from the vehicle and data from a database, the database containing (a) identifying data that identifies specific makes and models or Vehicle Identification Number (VIN) series that are subject to recalls or updates and (b) recall data that identifies which recall or updates should have been performed; and
determining that that recalls or updates have been performed on the vehicle.

12. The method of claim 11, wherein the recall data includes a nature of the recalls or updates, associated software revision numbers of the recalls or updates, and identifying recall numbers or names of the recalls or updates.

13. The method of claim 11, wherein the database further comprises a current listing of calibration identifications (CALIDs) associated with recalls or updates.

14. The method of claim 13, further comprising the steps of:
retrieving at least one CALID from the vehicle under inspection;
comparing the at least one CALID retrieved from the vehicle under inspection with the current listing of calibration identifications (CALIDs) associated with recalls or updates from the database; and
determining that that recalls or updates have been performed on the vehicle based on the comparison of the at least one CALID retrieved from the vehicle under inspection with the current listing of calibration identifications (CALIDs) associated with recalls or updates in the database, wherein a match of the at least one CALID retrieved from the vehicle under inspection with at least one of the current listing of calibration identifications (CALIDs) of the database indicates that the recall or update has been performed.

15. The method of claim 12, further comprising the step of modifying or creating an inspection log stored in a storage device of the vehicle under inspection, wherein the inspection log includes recall identification information including at least one time, date, location, identifying number or name of completed recalls or updates programmed into the vehicle.

16. The method of claim 15, further comprising the steps of:
retrieving the recall identification information from the inspection log from the vehicle under inspection;
comparing the recall identification information from the inspection log from the vehicle under inspection with the current listing of calibration identifications (CALIDs) associated with the current listing of recall identification information associated with recalls or updates in the database; and
determining that that recalls or updates have been performed on the vehicle based on the recall identification information in the inspection log, wherein a match of the recall identification information from the inspection log with at least one of the current listing of calibration identifications (CALIDs) of the database indicates that the recall or update has been performed.

17. The method of claim 16, wherein the inspection log of the vehicle under inspection includes both the calibration identifications (CALIDs) from the vehicle under inspection and the recall identification information.

18. The method of claim 11, wherein the database further comprises a listing of specific Vehicle Identification Numbers (VINs) of vehicles subject to recalls or updates along with relevant associated recall or update requirement information.

19. The method of claim 18, further comprising the steps of:
retrieving a Vehicle Identification Numbers (VIN) from the vehicle under inspection;
comparing the Vehicle Identification Numbers (VIN) with the listing of specific Vehicle Identification Numbers (VINs) of vehicles subject to recalls or updates in the database; and
determining if the vehicle under inspection is subject to a recall or update;
determining if the recall or update has been performed.

20. The method of claim 11, wherein the database is located either remotely from the device or within the device.
